(19) United States
(12) Patent Application Publication
(10) Pub. No.: US 2008/0084271 A1
(43) Pub. Date: Apr. 10, 2008

(54) Continuous variable wireless data input to RFID reader

(76) Inventors: Denny Jaeger, Oakland, CA (US); Andrew Lohbihler, Waterloo (CA)

Correspondence Address: ZIMMERMAN & CRONEN, LLP, 1330 BROADWAY, SUITE 710, OAKLAND, CA, 94612-2506, US

(21) Appl. No.: 11/973,122

(22) Filed: Oct. 5, 2007

Related U.S. Application Data
(60) Provisional application No. 60/849,986, filed on Oct. 6, 2006.

(51) Int. Cl. H04B 7/00

(52) U.S. Cl. 340/5.1

(57) ABSTRACT

A wireless data input system that has one or more continuous user input devices on a sensing pad or the like, each device connected to a respective individually addressable RFID tags. Each device operates to enable its corresponding individually addressable RFID tag to transmit a unique PN code or the like that is recognized by the RFID reader to identify the respective device and decode the data therefrom.

### CROSS-REFERENCE TO RELATED APPLICATIONS

This application claims the priority benefit of the filing date of Provisional Application no. 60/849,986, filed Oct. 6, 2006.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates generally to the field of radio frequency identification (RFID) systems and devices intended to sense the presence of an RFID transponder tag within a sensing field of a reader unit and to read an identification code unique to each such tag, thereby to identify a device associated with the tag using some form of continuous data input. More particularly, this invention is directed to a passive controlling function for accepting the simultaneous and continuous data input from multiple devices using induction or active type RFID readers, and more generally, to wireless data input to RFID readers or devices associated with RFID readers.

2. Description of Related Art

Radio frequency identification (RFID) systems have come into widespread usage in a wide range of applications. One such application is controlling access to restricted areas of buildings or plant facilities by authorized personnel while excluding those lacking the necessary authorization. Most such proximity systems consist of a transponder, a reader and a host computer. The reader generates a radio frequency (usually in the 125 kHz or 13.5 MHz range). The transponder usually consists of an antenna circuit (tuned to the same frequency as the output of the reader) and an integrated circuit (IC). Sufficient energy to activate the IC is obtained via induction when the transponder is placed within the field of the reader. The frequency of the reader is also used as a clock for the IC. When energized, the transponder IC loads the antenna circuit of the transponder in a pattern determined by the design and programming of the IC. The loading of the transponder antenna is detected as a pattern of voltage changes on the reader's antenna circuit. The changes are converted into logical data bits using standard decoding methods and the data is then interpreted by the host and appropriate action (such as opening the door) is taken.

Radio frequency identification systems have more recently also become active systems with battery powered tags. These systems generally transmit at 915 MHz and do not rely on the reader to power the tags because each tag must be sufficiently powered to receive an activation signal and transpond with a radio signal having a modulated tag code. The benefit of such devices is that they may easily transmit continuously and at high-speed data rates depending on the carrier wave frequency, and may use highly sensitive RF receiver technology. The drawback is that they require battery power that limits the life of operation, unlike induction tags that may operate indefinitely.

The topology of the various systems can range from a stand alone single door unit that contains the reader and the host in one small box mounted adjacent to a passageway to a complex system consisting of thousands of readers and other input/output devices connected to a communications network controlled by hundreds of host computers (running specialize software) that control access, personnel and property movement, lighting, HVAC, fuel dispensing and other functions. In stand alone, single door products and in some systems with distributed intelligence, the reader and host are often combined into a single entity.

There is a need to develop a “standalone” RFID reader system that employs continuous sensing devices that have their identity assigned by a code that is a reader tag. Each device will be inductively coupled with the reader device and depending how it is programmed will send coded data to the reader. This RFID reader is of the inductive type and is intended to function in conjunction with RFID tags that are passive bi-directional transponders in that power for the RFID tag is derived from the electromagnetic field generated by the reader. Each transponder consists of an integrated circuit and an antenna coil, both embedded in a small plastic token or tag. Examples of tag circuits currently available are sold by MicroChip Technology, Inc, Chandler, AZ as the MCRF355 miniature chip that can be programmed with specific codes and be controlled by a microprocessor (hereinafter “μP”).

More recently, RFID transponder tags have become available which are individually addressable by the RFID reader. That is, the tag does not automatically respond with its tag code when in the induction field of the RFID reader until it is specifically addressed or interrogated by the reader with that tag's unique tag identification code. This allows reading of multiple tags simultaneously present in the reader's radio frequency induction field. The RFID reader is pre-programmed with the unique identification code of each tag in the tag group or population to be read, and the reader executes a read scan or sequence during which it sequentially transmits, by modulating its induction field, the pre-programmed unique tag identification codes. The reader cycles through this read scan or sequence at a relatively high repetition rate sufficient to reasonably ensure that the presence of any one of the tags in the reader's sensing field does not go undetected.

An example of the prior art is U.S. Pat. No. 6,828,902, issued Dec. 7, 2004. It describes an example of a digital switch input to a reader using RFID tags. The disclosure discusses using a keypad with multiple switch keys allowing multiple digital switch input to a reader. The method does not require PN code modulation but uses coded tags to distinguish input keys from each other, for a total of 16 distinct keys. The keys are placed on a key-pad surface in close proximity to a reader antenna, allowing a user easy access to program an RFID reader.

The invention as disclosed herein is distinguished over prior are in the following ways: First, it is not limited to a switching action, but instead supports a continuous operation which enables knobs, faders and joysticks to be operated with RFID tags. This operation enables these devices to send data corresponding to continuous operation of these devices, e.g., turning a knob, moving a fader cap, adjusting a joystick, so that variable control values may be transmitted from the devices to the reader. Second, the invention offers the flexibility to operate multiple devices, knobs, faders, joysticks and switches, simultaneously using orthogonal code modulation, for example, a PN code. Third, the RFID tag code as used in this invention is chosen to be a PN code. Fourth, this PN code is modulated with data from the μP. Fifth, the power circuit of the RFID chip powers the μP for the time that it is needed to send a n-bit word. Sixth, an active tag is used instead of an active switched tag such that this active tag can continuously send data bits. Seventh, the μP utilized by this invention assigns a unique time delay for each device. These time delays allow multiple PN codes to not collide with each other. Eighth, the continuously sent data bits can be used to alter graphical or iconic data on a computer screen.

Generally many patented RFID technologies discuss the use of modulating codes for RFIDs with the use of Manchester or Bi-Phase codes. These codes are not PN code sequences and have a very limited ability to distinguish different devices operating simultaneously.

### BRIEF SUMMARY OF THE INVENTION

This invention addresses the aforementioned need by providing a simple means to allow continuous data input from RFID tag devices to induction or active type RFID readers. The elements of this invention are of economical design, requiring only three main components: a sensor pad, an antenna and a number of commercially available, low cost transponder tags installed inside devices that operate on the sensor pad. Each of the transponder tags, when connected to the antenna by actuation of a switch on the device, communicates with the RFID reader by loading down the electromagnetic field in the vicinity of the transmitter antenna of the reader in a temporal pattern that the reader interprets and decodes as digital data.

More specifically, the continuous device input of this invention is intended for use with an induction type RFID reader having radio frequency (RF) sensing means operatively connected to a digital processor, such as a microprocessor, for reading tag identification data of RFID transponder tags powered by a sensing field of the reader and for verifying the identification data against stored identification data thereby to recognize the presence of authorized tags. The tags will be generally coded with PN code bit sequences that are orthogonal to each other for the benefit of operating the devices and associated tags simultaneously.

The RFID reader which may be a hand held unit houses an antenna, such as a loop antenna, a number of dedicated RFID transponder tags each having a unique tag PN code, and a sensor pad having a plurality of input devices, each device incorporating one of the RFID tags. Each device is selectively operable by connecting its dedicated RFID transponder tag to the device antenna, thereby to inductively power the selected tag in the reader's sensing field and enable the unique tag code of the selected tag to be read by the RFID reader. The RFID reader operates in conjunction with the reader's processor to recognize the unique tag PN codes of the dedicated tags to determine the tag identity and decode the continuous variable input data.

If an active RFID is used instead, then the reader is a sensitive RF receiver that may demodulate using a direct demodulator or a standard super-heterodyne receiver to create a baseband data signal. The active reader will generate an activation signal to trigger an active tag (or multiple active tags) to transmit a unique PN code to be detected by the receiver.

In a broader sense, the present invention may be understood as a method for wireless linkage of one or more variable input knob, fader, joystick and switch devices to an induction type RFID reader, comprising the following steps: (a) providing one or more individually actuatable devices, (b) connecting each of the devices to a corresponding RFID transponder tag and an antenna such that closing a particular switch places a corresponding transponder tag in operative connection with the antenna for inductively communicating a unique identification code of the tag to the RFID reader; and, (3) as an option, using a processor to program the RFID reader for recognizing the unique identification code of each tag to recognize the reading of those tags as representing the actuation of a device and continuous flow of data to the reader. It should be noted that the knobs, faders, joysticks and switches of this invention may operate simultaneously sending data to the reader and that the data can be represented as graphics presented on a computer screen by a computer program.

It is further an intention of this invention to allow the RFID reader to be programmable with new devices by sensing their respective PN codes, assuming it is not a code shared with another device and transmitted with the same code length and data rate. A reader processor can be programmed to recognize and log a new device code. Similarly, the reader can be programmed to reject specific device codes if required.

These and other features, improvements and advantages of the present invention can be understood by reference to the following detailed description taken in conjunction with the accompanying drawings.

### BRIEF DESCRIPTION OF THE DRAWING

FIG. 1 is a perspective view illustrating a typical sensor pad RFID reader equipped with continuously variable input devices such as a knob or fader of the present invention.

FIG. 2 is a block diagram of the PN code modulated tag and processor of the present invention.

FIG. 3a is a graphic representation of the data send protocol for each continuous input device using induction RFID tags of the present invention, and FIG. 3b is a graphic representation of the data send protocol for each continuous input device using active RFID tags of the present invention.

FIG. 4 is a block diagram of a wireless data input system with a processor-assisted reader of the present invention.

FIG. 5 is a table showing the multiple operation of devices that use PN codes for identification and modulation of digital data using RFID transponder tags of the present invention.

FIG. 6a is a block diagram of a device process using a single switch with the sensor pad RFID reader and PN code of the present invention, and FIG. 6b is a block diagram of a device process using multiple switches with said sensor pad RFID reader and PN code of the present invention.

### DETAILED DESCRIPTION OF THE INVENTION

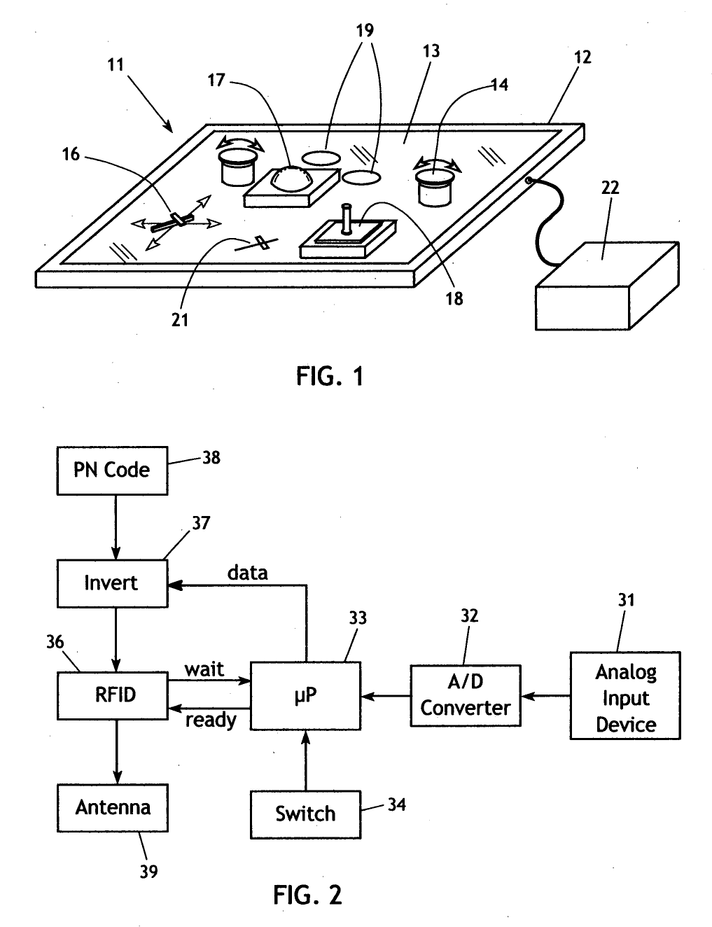

The present invention generally comprises a simple means to allow continuous data input from RFID tag devices to induction or active type RFID readers. With regard to FIG. 1, a typical proximity RFID reader unit 11 includes a reader housing 12 which surrounds and supports a sensor pad 13. In most cases such a design will consist of a stand-alone sensor pad with a limited number of user input devices that provide a continuous variable output reading and must be transmitted to the RFID reader as digital signals. The user input devices may include knobs 14, faders 16, trackballs 17, joysticks 18 and various types of switches that are physically operated by a user. The sensor pad area may also be used for other forms of continuous input but must rely on the tag for communication. The sensor pad surface and reader housing may also be placed over a LCD screen so that iconic representations 19 and 21 of the knob and fader inputs are displayed on the LCD screen. These iconic representations could include any type of graphic with any type of digital readout, like numerals that change as a knob is turned, a fader cap is moved, a joystick is adjusted or a switch is pushed. The housing 12 may be a small enclosure sized for convenient hand held operation. The reader unit 11 is connected to a controller and processor unit 22 by wire or wireless connections.

With regard to FIG. 2, in one embodiment of the invention each user input device (14, 16, 17, 18) includes the elements for passive remote transmission of data to the RFID reader 11. The analog input sensor of the user input device 31, such as the knob angular position sensor, fader linear position sensor, joystick XY position sensor, and trackball angular axis sensor, generates a sensor signal that is fed to an A/D converter 32, and the resulting digital signal is fed to a microprocessor 33. The digital input can also be the input from a switch and in this case a single bit representing the switching action is sent to the μP 33. A switch 34 is connected to the μP to activate the μP into operation thereby allowing the digital stream of data to be output to the RFID circuit 36. In addition, the PN code 38 is stored in a non-volatile memory and connected through an inverter 37 to the RFID circuit 36. The μP 33 is connected by a data line to the inverter 37 to selectively invert the PN code as it is fed therethrough to the RFID circuit 36. The resulting coded signal is fed to antenna 39, which interacts with the antenna of the RFID reader 11 as is well-known in the prior art.

For knobs, faders and joysticks, a preferred switch for this activation operation is a touch sensitive switch that will activate the device upon contact with a human hand or finger. For instance, grabbing a knob between the thumb and forefinger or using a finger to slide a fader cap or adjust a joystick. Of course, a mechanical switch can also be used. If the device is a switch, then it simply activates the RFID and turns it on.

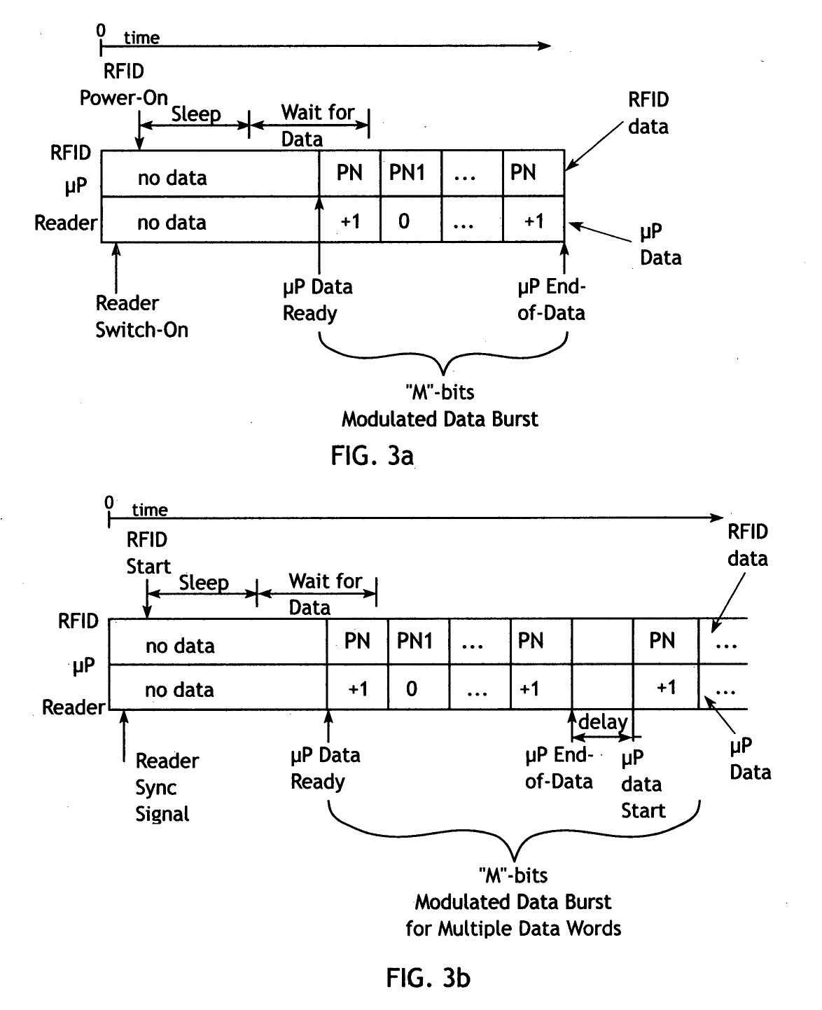

The data transmission protocol for continuous devices using inductive RFIDs is shown in FIG. 3a. For induction type RFID tags the process of data reading and coding from a continuously operating variable input device uses an RFID that receives a data-ready input signal from a μP. When the reader powers up the induction RFID tag to respond (reader switch-on), the RFID very soon receives a RFID power-on signal as the tag receives the inductively transmitted power. The RFID then goes into a sleep state while data is prepared in the μP 33. A data-ready signal must reply from the μP within a delay time or wait-for-data period to indicate that there is data ready to transmit, otherwise there is no tag reply. Note that the delay or sleep period is specific or unique to the device, as each different device may have a different delay or sleep time the μP begins to transmit the PN code and inverted PN code to convey the device ID as well as the data from the analog input device 31. When the data-ready signal is active then the tag will respond by sending a PN code that is repeated M times. For example if an ASCII character is sent then the PN code is repeated 8 times (M=8). Also the PN code can be modulated in various ways. For example, the PN code can be sent as on-off PN code sequences using appropriate lead and trail bits, or using direct and inverted PN code sequences. Also by example, the RFID chip can send M code responses with a data-ready capability and an ability to invert the code as well. The first approach above is easier because it requires that an RFID chip have an ability to send M code responses with a data-ready capability. Each PN burst results in a binary one data bit accumulated in the reader, and each PN1 results in a binary zero bit. (Each PN1 word may comprise the inverted PN code.) When the PN word transmission in complete, the μP sends a end-of-data signal to the RFID circuit, indicating that the M-bit modulated data burst is complete.

The data transmission protocol for continuous devices using active RFIDs is shown in FIG. 3b. The process is almost identical to the inductive device but one difference is that the reader must transmit a short activation signal (reader sync signal) to the RFID tag requiring the tag to reply within a specific delay or sleep time period to a data-ready signal from the μP with modulated data. Another distinction is that the RFID tag can reply with M responses or many more depending on how the tag device is programmed, since it does not rely on the uncertain reader signal to power the tag.

One advantage of using the above RFID powering and data transmission schemes shown in FIGS. 3a and 3b, is that they will operate with a reader that is sending a continuous or pulsed EM field. The reader can continuously send an EM field and simultaneously receive data, or the reader may pulse the EM field at predetermined time intervals long enough to power the RFID tag and μP circuits to allow the RFID to send a required return data signal within the power cycle.

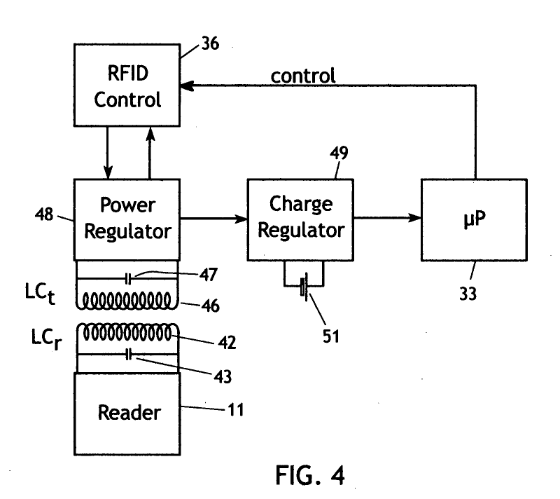

FIG. 4 depicts the elements of the power circuit of each RFID device. This circuit requires few components and allows for the whole circuit to be powered directly from the reader depending on the RF signal strength. Reader 11 is provided with an antenna circuit comprised of an inductor 42 in parallel with capacitor 43, whereby the LCᵣ factor determines the resonant frequency of the antenna circuit. Each RFID device includes a similar antenna circuit comprised of inductor 46 in parallel with capacitor 47 to produce an LCₜ factor that tunes the RFID antenna circuit to the reader antenna circuit. The RFID antenna circuit is connected to power regulator 48, which in turn delivers power to a charge regulator 49. The power from charge regulator 49 is fed to the μP 33, which powers the μP and causes it to deliver a control signal to the RFID circuit 36. If the combination of the μP and tag circuit cannot be powered as a single unit by the instantaneous power of the reader power signal, then an optional battery 51(typically a long life lithium, or the like) is connected to the charge regulator to allow for sufficient powering of the μP and analog input component. That is, the battery may be charged when the device is not transmitting, and may accumulate sufficient power to drive the RFID transmission protocol (described above) when necessary.

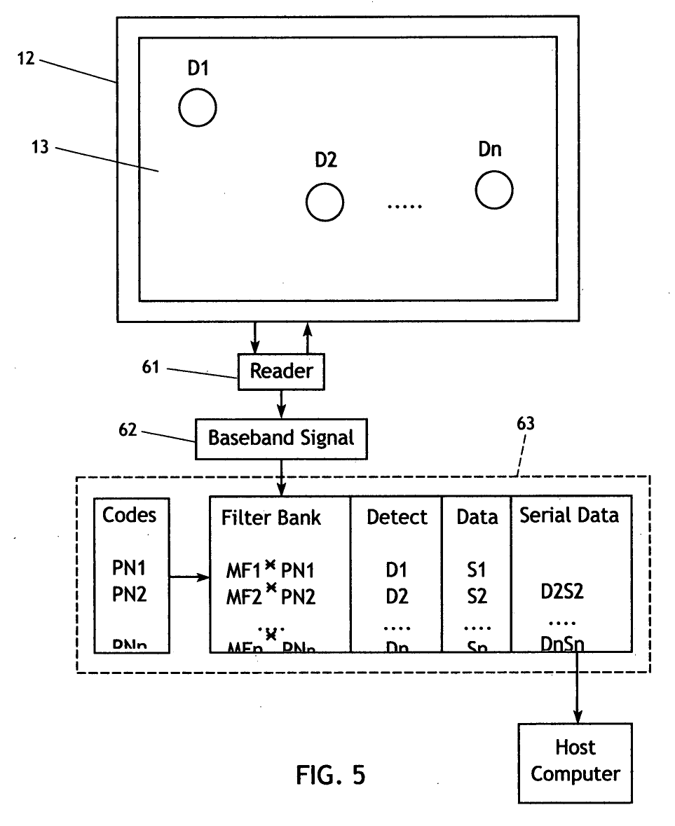

FIG. 5 illustrates the multiple device operation of the sensor pad. Devices D1 through Dn are normally placed down on the sensor pad in locations corresponding to respective multiple graphical representations (1 to N) displayed on a computer screen, such as the representations 19 and 21 of FIG. 1. In this case each graphical representation is a circle or graphical knob shown on a computer screen which is situated below the transparent sensor pad. The computer screen may be an LCD under the sensor pad surface, or a stand-alone computer screen separate from the sensor pad surface. The transponder (tag) circuits inside each of the knob, fader, joystick, trackball, or switch devices on the sensor pad surface are programmed so that each transmits a unique identification PN code when activated by the inductive sensing field of a proximity reader 61. The input of each tag circuit is connected to the output of the μP of each knob, fader, joystick or switch represented as D1-Dn, as described above. Changes caused by adjusting a device, e.g., turning a knob, moving a fader or joystick, are represented as digital data, which are transmitted to the antenna tank circuit of the tag. The operative tag will be powered up by energy inductively coupled from the reader to the antenna coil, and will transmit its unique tag PN code to the reader. The μP assigns a unique time delay (as shown in FIG. 3b) for each device called T1 to Tn. These unique times are important to prevent multiple PN codes from colliding with each other. Although code collision is allowed, it is desirable to minimize these effects as much as possible (to perhaps a maximum of two or three code collisions for each transmission of a data code word). The transponder tag circuit may comprise an IC with surface mount components such that the entire circuit of FIG. 2 can be easily implemented on a single circuit board, which can also carry the μP, analog input device, and antenna coil. Alternatively, this entire circuit could be reduced to an ASIC.

The reader 61 receives the raw PN code burst from all the devices D1-Dn, and produces a baseband signal 62 that is fed to a CDMA processor 63. The CDMA processor process compares the broadband signal to a filter bank of PN codes that contains all the codes of the devices D1-Dn. When code PN1 is fed to the filter bank having stored codes MF1 . . . MFn, it is compared with all the programmed codes until a match with MF1 is found, leading to device D1 being detected. The data content of D1, here termed S1 is derived from the burst. Likewise PN2 is matched against all codes until a match with MF2 is found leading to detection of D2 and derivation of data S2. This process is carried out until code PNn is matched with MFn, and the related data is read. The serial data D2S2 to DnSn is fed from the CDMA processor to the host computer, which typically also operates the electronic display associated with the sensor pad. Assuming that the data thus derived replicates at least some changes in the settings of the devices D1-Dn, the host computer may update the display appropriately to portray graphically the altered settings of the devices.

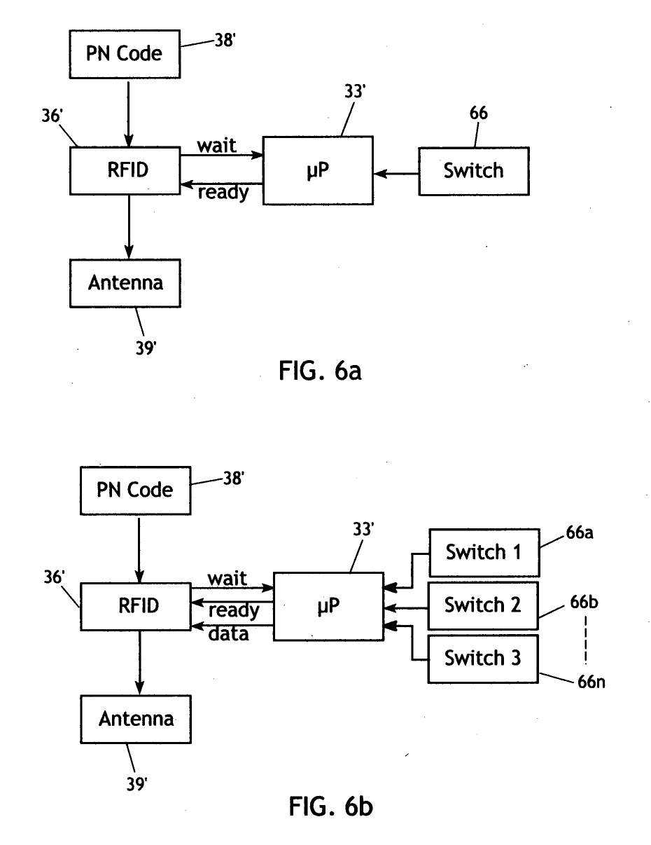

With regard to FIG. 6a, there is shown the implementation of a simple data RFID device, and the components that are similar to those of FIG. 2 are labelled with the same reference numerals having a prime (′) designation. The input device to the μP 33′ is a switch 66 that convey a single event bit to the RFID circuit 36′ (i.e. for M=1). Note that a device having a simple SPST switch will only send one PN code sequence and does not need to invert the code. This device design is programmed with a μP to allow the RFID to delay sending the PN code depending on the status of the RFID and timing of the switch event. It is the intention of this design to allow a switch as a standalone option for a user input device, or add it as an additional function to any existing device for an independent switching purpose. For example, a knob, fader or joystick can have a plurality of switches that may send single bit events for purposes that are independent of the continuous input of data. FIG. 6b shows another implementation that is similar to FIG. 6a, except that the device may employ multiple switches 66a-66n and may use the input data stream to identify the switch being activated (i.e. M>1 for two or more switches on one device).

The reader 61 (FIG. 5) consists of two significant parts: the RF front-end and the processor. The processor is required to recognize the unique tag PN codes of the transponder tags that are dedicated to a function of sending ordinary binary data from the user input devices to the reader. In particular, the reader will recognize the dedicated tag PN codes using a high-speed RF coupling decoder circuit followed by a combination of matched filters to recognize the PN codes from the decoder's base-band signal output. The base-band signal can be over-sampled by some facto N. For instance a factor of 5 or greater than the highest chipping frequency of the PN code transmitted from the tag. As an example, if a reader can decouple a tag signal chipping at 70 kHz then the reader's base-band signal shall be sampled at 350 kHz or better at 700 kHz to allow for a better quality PN code to be matched. The ultimate objective is to decode the modulation of the PN code to determine the digital read-out of the analog device inside each user input device. Over-sampling is useful not only for the quality of the decoding but mainly for the ability to operate multiple PN coded devices simultaneously.

Once the tag PN codes have been decoded the reader's processor will also arrange recognized data from the devices as a packet structure that includes the device ID, and the continuous digital reading of the analog input device (by example, this could be as a single 8-bit ASCII character) or a sequence of 8 bit or 16-bit representations of the signal. Depending on the number of devices operating simultaneously, the reader's processor must arrange the output data packets such that there is sufficient bandwidth to serially communicate to a computer program performing iconic representations of the devices.

A further embodiment of this invention permits a reader's processor to be programmed to allow a new device to be placed on the sensor pad and accept the unknown code to be programmed into the processor. A newly scanned PN code that is not matched with an existing code can be recognized and logged for further use. Similarly, with the aid of the host computer the processor can allow an administrative user to disable the device PN code from further operation on the sensor pad.

The number and functions of sensor pad user input devices that can be encoded and wirelessly linked to a reader in this fashion is virtually unlimited. As a practical matter, however, it may be found that this approach to passive remote devices representation'is best suited to a relatively small sensor pad with a simple square reader antenna surrounding the outside of the sensor pad area. RFID units requiring large and complex sensor pads are better implemented with a fractal antenna pattern surface etched on, for example, an ITO (Indium-Tin Oxide) conductive surface or its equivalent.

It should be understood that this invention is not restricted to any particular manufacturer's proximity system, and is generally useful with any induction type proximity reader, provided that the tags used in the remote programmer unit can be read by the target proximity reader. Generally there are many commercial reader front-end circuits available (from companies like MicroChip, Phillips, Tex. instruments, etc.) and may be linked to an FPGA or any other suitable DSP that can support high-speed matched filter implementations.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for wireless connection of a plurality of devices to an induction type RFID reader comprising the steps of:
providing a sensor pad having a plurality of physically operable continuous input devices;
providing a plurality of individually addressable RFID transponder tags;
connecting each of said devices to a respective one of said plurality of RFID transponder tags and an antenna such that actuating at least one of said input devices places the respective transponder tag in operative connection with said antenna for inductively transmitting a unique set of tag identification codes to the RFID reader; and
executing program means in the RFID reader for recognizing said unique set of tag identification PN codes as representative of actuation of a particular device on said sensor pad.

2. The method of claim 1 further comprising the step of providing a unique time delay for each of said plurality of RFID transponder tags after each RFID transponder tag is placed in operative connection with said antenna to minimize collisions of the PN codes from the plurality of RFID transponder tags at said RFID reader.

3. The method of claim 1, further including the step of encoding data in said PN codes by transmitting the respective PN code burst to represent a positive binary bit, and transmitting the respective PN code in inverted form to represent a negative binary bit.

4. The method of claim 1, further including the step of enabling said program means to recognize and record RFID transponder tags if not previously detected or operated on said sensor pad.

5. An RFID system comprising:
an RFID reader having sensing means operatively connected to a microprocessor for receiving signals from a population of individually addressable RFID tags;
a plurality of user operated input devices;
a plurality of individually addressable RFID transponder tags, each having a unique tag code, each RFID transponder tag connected to one of said user operated input devices for data transmission to said RFID reader.

6. The RFID system of claim 5 wherein each of said input devices is physically operable as a continuously variable input device on a sensor pad.

7. The RFID system of claim 5 wherein said user operated input devices are selected from the group consisting of knobs, faders, joysticks, trackballs, and switches.

8. The RFID system of claim 5 wherein said RFID reader is programmable to allow individually addressable RFID transponder tags to be recognizable and recordable if not previously detected or operated on said system.

9. The RFID reader system of claim 5 wherein said RFID reader is programmable to allow individually addressable RFID transponder tags to be removed if previously detected or operated on said system.

10. A wireless sensor pad having a plurality of input devices, each input device connected to a respective one of a plurality of RFID transponder tags, each transponder tag having a unique PN code, said input devices being operable for enabling a corresponding set of individually addressable RFID transponder tags in an induction field of an RFID reader, each tag in said set comprising a unique combination of modulating PN codes,
an RFID reader programmable to recognize actuation of particular ones of said device PN codes thereby to receive continuous data inputs from said sensor pad.
